(19) United States
(12) Patent Application Publication
(10) Pub. No.: US 2017/0096840 A1
(43) Pub. Date: Apr. 6, 2017

(54) Security Lock System

(71) Applicants: Willie Henderson, SR., Stockton, CA (US); Sederia Henderson, Stockton, CA (US)

(72) Inventors: Willie Henderson, SR., Stockton, CA (US); Sederia Henderson, Stockton, CA (US)

(21) Appl. No.: 14/872,366

(22) Filed: Oct. 1, 2015

(51) Int. Cl. E05B 65/00; E05F 15/77

(52) U.S. Cl. CPC E05B 65/0021; E05F 15/77; E05Y 2201/22; E05Y 2900/106

(57) ABSTRACT

A security lock system includes a garage door opener has a carrier, a track and a release. The carrier is slidably coupled to the track. The release is hingedly coupled to the carrier. The release is positionable in a locked position such that such carrier is inhibited from is manually slid along the track. The release is positionable in an unlocked position such that carrier freely moves along the track. A lock is coupled between the release and the carrier such that release is prevented from is positioned in the unlocked position. Thus, the lock inhibits an intruder from remotely positioning the release in the unlocked position.

### BACKGROUND OF THE DISCLOSURE

### Field of the Disclosure

The disclosure relates to lock devices and more particularly pertains to a new lock device for preventing a garage door from being manually opened.

### SUMMARY OF THE DISCLOSURE

An embodiment of the disclosure meets the needs presented above by generally comprising a garage door opener has a carrier, a track and a release. The carrier is slidably coupled to the track. The release is hingedly coupled to the carrier. The release is positionable in a locked position such that such carrier is inhibited from is manually slid along the track. The release is positionable in an unlocked position such that carrier freely moves along the track. A lock is coupled between the release and the carrier such that release is prevented from is positioned in the unlocked position. Thus, the lock inhibits an intruder from remotely positioning the release in the unlocked position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective kit view of a security lock system according to an embodiment of the disclosure.

FIG. 2 is a right side view of an embodiment of the disclosure.

FIG. 3 is a perspective in-use view of an embodiment of the disclosure.

FIG. 4 is a cross sectional view taken along line 4-4 of FIG. 3 of an embodiment of the disclosure.

### DESCRIPTION OF THE PREFERRED EMBODIMENT

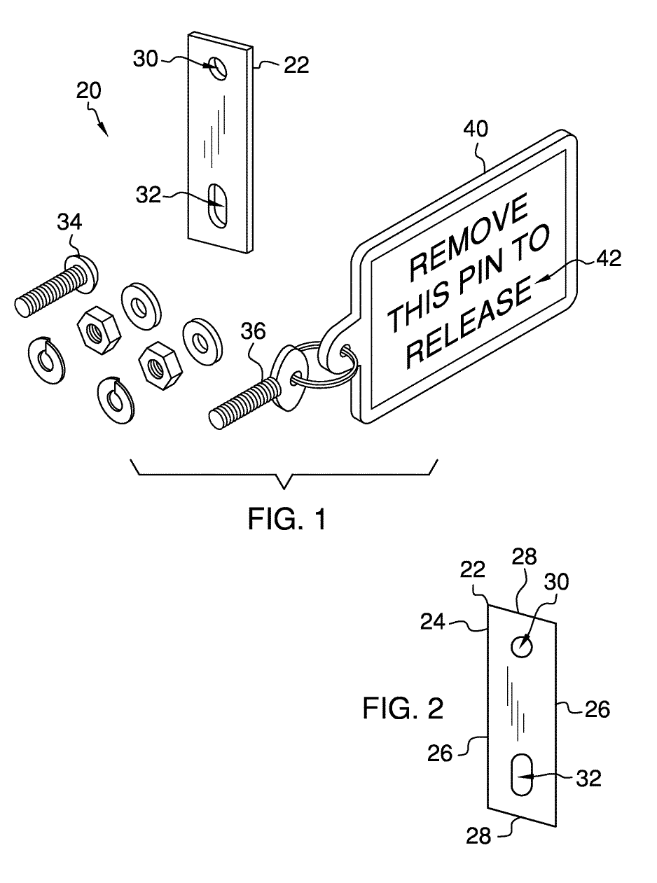

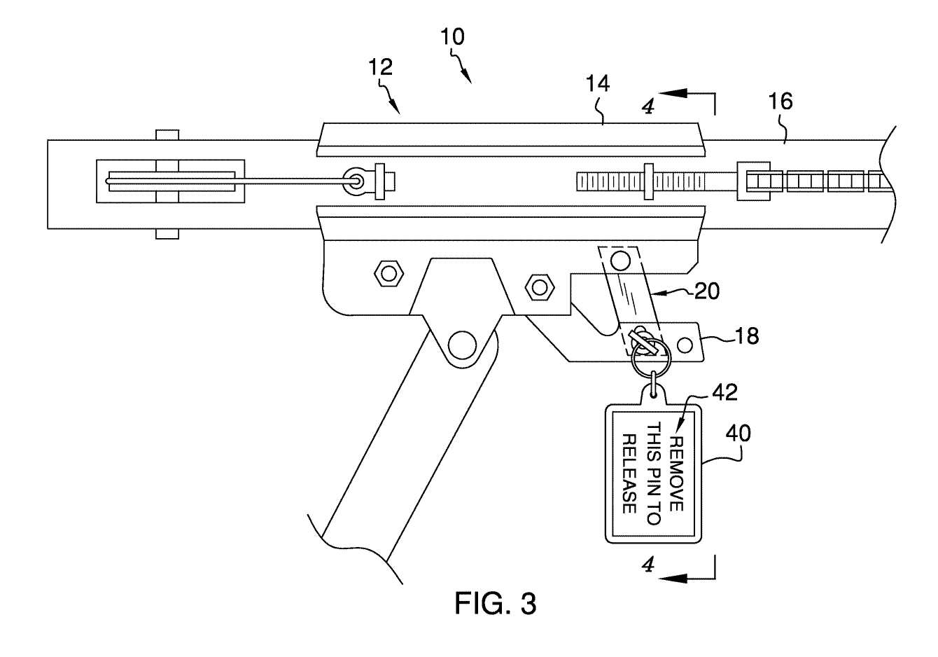

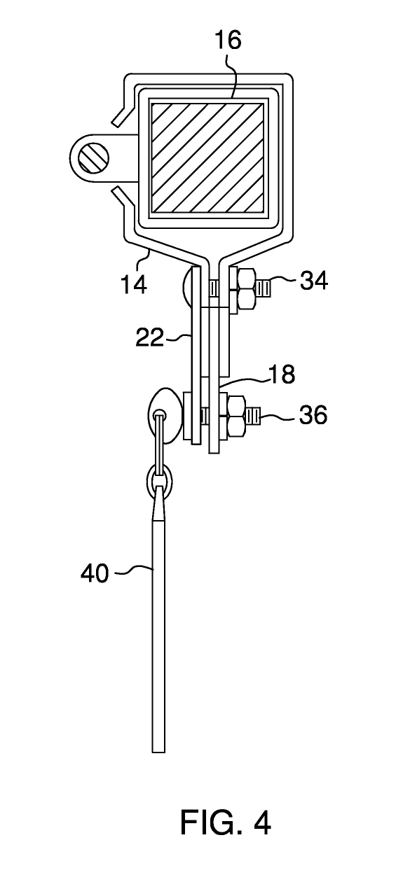

With reference now to the drawings, and in particular to FIGS. 1 through 4 thereof, a new lock device embodying the principles and concepts of an embodiment of the disclosure and generally designated by the reference numeral 10 will be described.

As best illustrated in FIGS. 1 through 4, the security lock system 10 generally comprises a garage door opener 12 that has a carrier 14, a track 16 and a release 18. The carrier 14 is slidably coupled to the track 16 and the release 18 is hingedly coupled to the carrier 14. The release 18 is positionable in a locked position such that such carrier 14 is inhibited from being manually slid along the track 16. The release 18 is positionable in an unlocked position such that carrier 14 freely moves along the track 16. The garage door opener 12 may comprise a remotely controlled garage door opener or the like.

A lock 20 is provided. The lock 20 is coupled between the release 18 and the carrier 14. Thus, the release 18 is prevented from being positioned in the unlocked position. The lock 20 inhibits an intruder from remotely positioning the release 18 in the unlocked position.

The lock 20 comprises a bracket 22 that has peripheral edge 24. The peripheral edge 24 has a pair of lateral sides 26 and a pair of end sides 28. Each of the end sides 28 angles between each of the lateral sides 26 such that the bracket 22 forms a parallelogram. Thus, the bracket 22 may be positioned to angle between the carrier 14 and the release 18. The bracket 22 may have a length ranging between five cm and seven cm.

The bracket 22 has a first aperture 30 extending therethrough. The bracket 22 has a second aperture 32 extending therethrough. The first aperture 30 is spaced from the second aperture 32. The second aperture 32 is elongated such that the second aperture 32 has an ovoid shape. The bracket 22 is positioned to extend between the carrier 14 and the release 18.

A first fastener 34 is extended through the first aperture 30 and engages the carrier 14 such that the bracket 22 is coupled to the carrier 14. The first fastener 30 may comprise a nut and a bolt or the like. A second fastener 36 is extended through the second aperture 32 and engages the release 18 such that the release 18 is retained in the locked position. The second fastener 36 is removed from the second aperture 32 such that the release 18 is positionable in the unlocked position. The second fastener 32 may comprise a thumb screw and a nut or the like.

A tag 40 is coupled to the second fastener 36. The tag 40 has indicia 42 are printed thereon. The indicia 42 may comprise the words “Remove This Pin To Release”. The indicia 42 communicate instructions to remove the second fastener 32 in order to position the release in the unlocked position.

In use, the bracket 22 is positioned between the carrier 14 and the release 18. The first fastener 34 is extended through the carrier 14 and the bracket 22. The second fastener 36 is extended through the release 18 and the bracket 22. Thus, the release 18 may not be remotely positioned in the unlocked position thereby inhibiting unwarranted access into a garage or the like. The second fastener 36 is removed from the bracket 22. Thus, the release 18 is positionable in the unlocked position thereby facilitating a garage door to be manually opened.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A security lock system comprising:
a garage door opener having a carrier, a track and a release, said carrier being slidably coupled to said track, said release being hingedly coupled to said carrier, said release being positionable in a locked position such that such carrier is inhibited from being manually slid along said track, said release being positionable in an unlocked position such that carrier freely moves along said track; and
a lock being coupled between said release and said carrier such that release is prevented from being positioned in said unlocked position wherein said lock is configured to inhibit an intruder from remotely positioning said release in said unlocked position.

2. The system according to claim 1, wherein said lock comprises a bracket having peripheral edge, said peripheral edge having a pair of lateral sides and a pair of end sides, each of said end sides angling between each of said lateral sides such that said bracket forms a parallelogram.

3. The system according to claim 2, wherein said bracket has a first aperture extending therethrough.

4. The system according to claim 3, wherein said bracket has a second aperture extending therethrough, said first aperture being spaced from said second aperture, said second aperture being elongated such that said second aperture has an ovoid shape, said bracket being positioned to extend between said carrier and said release.

5. The system according to claim 1, further comprising:
a bracket having a first aperture; and
a first fastener being extended through said first aperture and engaging said carrier such that said bracket is coupled to said carrier.

6. The system according to claim 1, further comprising:
a bracket having a second aperture; and
a second fastener being extended through said second aperture and engaging said release such that said release is retained in said locked position, said second fastener being removed from said second aperture such that said release is positionable in said unlocked position.

7. The system according to claim 6, further comprising a tag being coupled to said second fastener, said tag having indicia being printed thereon.

8. A security lock system comprising:
a garage door opener having a carrier, a track and a release, said carrier being slidably coupled to said track, said release being hingedly coupled to said carrier, said release being positionable in a locked position such that such carrier is inhibited from being manually slid along said track, said release being positionable in an unlocked position such that carrier freely moves along said track; and
a lock being coupled between said release and said carrier such that release is prevented from being positioned in said unlocked position wherein said lock is configured to inhibit an intruder from positioning said release in said unlocked position, said lock comprising:
a bracket having peripheral edge, said peripheral edge having a pair of lateral sides and a pair of end sides, each of said end sides angling between each of said lateral sides such that said bracket forms a parallelogram, said bracket having a first aperture extending therethrough, said bracket having a second aperture extending therethrough, said first aperture being spaced from said second aperture, said second aperture being elongated such that said second aperture has an ovoid shape, said bracket being positioned to extend between said carrier and said release,
a first fastener being extended through said first aperture and engaging said carrier such that said bracket is coupled to said carrier,
a second fastener being extended through said second aperture and engaging said release such that said release is retained in said locked position, said second fastener being removed from said second aperture such that said release is positionable in said unlocked position, and
a tag being coupled to said second fastener, said tag having indicia being printed thereon.
